(19) United States
(12) Patent Application Publication
(10) Pub. No.: US 2008/0130417 A1
(43) Pub. Date: Jun. 5, 2008

(54) SENSOR CLOCK

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/566,198

(22) Filed: Dec. 1, 2006

(51) Int. Cl. G04B 47/06; G06Q 30/00

(52) U.S. Cl. 368/11; 705/14

(57) ABSTRACT

A multi-signal desktop digital displayer that can selectively display digital information generated from common digital utilities such as a clock, timer, alarm, or thermometer, one by one, upon detecting a motion nearby such as a user's hand waving via a motion sensor. The multi-signal displayer has a housing to encase the electric circuitry of those digital utilities, a display to display the digital signals, and a motion sensor disposed on the housing and emitting electromagnetic wave to define a motion field extending therefrom. The motion sensor is configured such that whenever it senses a motion within the motion field such as a waving hand, it generates an electrical signal for consecutively activating the digital signal generators, one by one, following a predetermined order, and thereby displaying a different digital signal generated therefrom on the display.

The present invention relates to field of a desktop displayer that selectively displays multiple digital signals, such as time, date, alarm setting, countdown timer, or temperature via a motion sensor disposed thereon.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

Desktop digital assemblies that conveniently incorporate common digital utilities such as a clock, timer, alarm, or thermometer, are widely used in business offices, houses, or other living spaces. Some of those digital desktop assemblies commercially available in the market are designed to display all different kinds of digital signals together on a single or multiple digital screens. Others are designed to display selectively only a single kind of digital signal at a time via some signal selection means attached thereon.

When buyers make a purchase decision among various such digital assemblies available in the market, they often consider not only the functionality, convenience or efficiency in operating those incorporated digital functions, but also how the operating means are designed creatively so as to enhance the aesthetics of the product as well, being combined or harmonized with the aesthetic features thereof, since in modern days, such a digital desktop assembly also serves as an important part of room decoration. Therefore, it would be advantageous if a multi-signal desktop digital displayer is designed not only to carry various widely-used desktop digital functions, but also to have its functional features combined with aesthetical features to attract the attention of buyers or viewers.

Motion sensors have been used in many applications. They have been applied to a lighting system where a light is turned on when someone enters the “motion field” created by the sensor. They have been employed also in a few alarm clocks, such as the “Wave Logic Travel Clock” manufactured by Saitek Ltd. or “Remington Motion Control Projection Clock”, in which the infrared sensor has been used to silence the alarm sound for some predetermined time or control the light attached to the clock by dimming/brightening or turning the light on/off or upon detection of a motion such as ‘waving hand’ in the motion field of the sensor. U.S. Pat. No. 5,524,101 issued to Thorgersen discloses an alarm clock having a motion sensor to silence alarm sound for some time and lighten up electroluminescent clock dial.

Although several kinds of multi-signal desktop displayers that can selectively display one kind of signals at a time exist in the prior art, none of them, however, discloses using a motion sensor to activate various signal generators consecutively following a preset order so as to display digital signals generated therefrom one by one. Therefore, it is desirable to provide a multi-signal desktop displayer in which various kinds of common digital information such as time, date, alarm, timer, and temperature displayed thereon can be conveniently changed one by one, following a predetermined order, by detecting a motion occurring in the vicinity of the displayer such as a ‘waving hand’. Further, it would be desirable if such desktop multi-signal displayer can provide even some space to place advertising materials for advertisement.

### SUMMARY OF THE INVENTION

The present invention provides a multi-signal desktop digital displayer that can selectively display digital information generated from common digital utilities such as a clock, timer, alarm, or thermometer, one by one, upon detecting a motion nearby such as a user's hand waving via a motion sensor.

The multi-signal displayer made in accordance with the present invention is largely comprised, in the preferred embodiment, of a housing, disposed therein, a plurality of digital signal generators, such as a clock, timer, alarm, or thermometer, a display to display the digital signals, and a motion sensor disposed on the housing and emitting electromagnetic wave to define a motion field extending therefrom. The motion sensor is configured such that whenever it senses a motion within the motion field such as a ‘waving hand,’ it generates an electrical signal for consecutively activating the digital signal generators, one by one, following a predetermined order, and thereby displaying a different digital signal generated therefrom on the display.

The multi-signal displayer may further have a plurality of input units on an outer surface of the housing for time and alarm setting, and advertising material disposed on a visible outer surface thereof.

### BRIEF DESCRIPTION OF THE DRAWINGS

FIG. 1 is a perspective view of the multi-signal displayer made in the preferred embodiment of the present invention;

FIG. 2 is a front elevational view of the multi-signal displayer made in the preferred embodiment of the present invention;

FIG. 3 is a slightly tilted top plan view of the multi-signal displayer made in the preferred embodiment of the present invention;

FIG. 4 is a side elevational view of the multi-signal displayer made in the preferred embodiment of the present invention;

FIG. 5 is a rear elevational view of the multi-signal displayer made in the preferred embodiment of the present invention; and

FIG. 6 is a bottom plan view, in the perspective, of the multi-signal displayer made in the preferred embodiment of the present invention.

### DETAILED DESCRIPTION OF THE INVENTION

The present invention generally relates to a multi-signal desktop digital displayer that can selectively display common digital utilities such as a clock, timer, alarm, or thermometer, one by one, upon detecting a motion nearby such as a user's hand waving via a motion detector.

Several preferred embodiments of the present invention will now be described with reference to figures (‘FIGS.’) 1-6, wherein like components are designated by like reference numerals throughout the figures. With regard to means for fastening, mounting, attaching or connecting the components of the present invention to form the assembly as a whole, unless specifically described otherwise, such means are intended to at least encompass conventional fasteners such as machine screws, machine threads, snap rings, hose clamps, rivets, nuts and bolts, toggles, pins and the like. Components may also be connected by friction fitting, snap fitting, adhesives or by welding or deformation, if appropriate. Unless specifically otherwise disclosed or taught, materials for making components of the present invention are selected from appropriate materials such as metal, ceramics, metallic alloys, natural or synthetic fibers, plastics and the like, and appropriate manufacturing or production methods including casting, extruding, injection molding and machines may be used.

Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

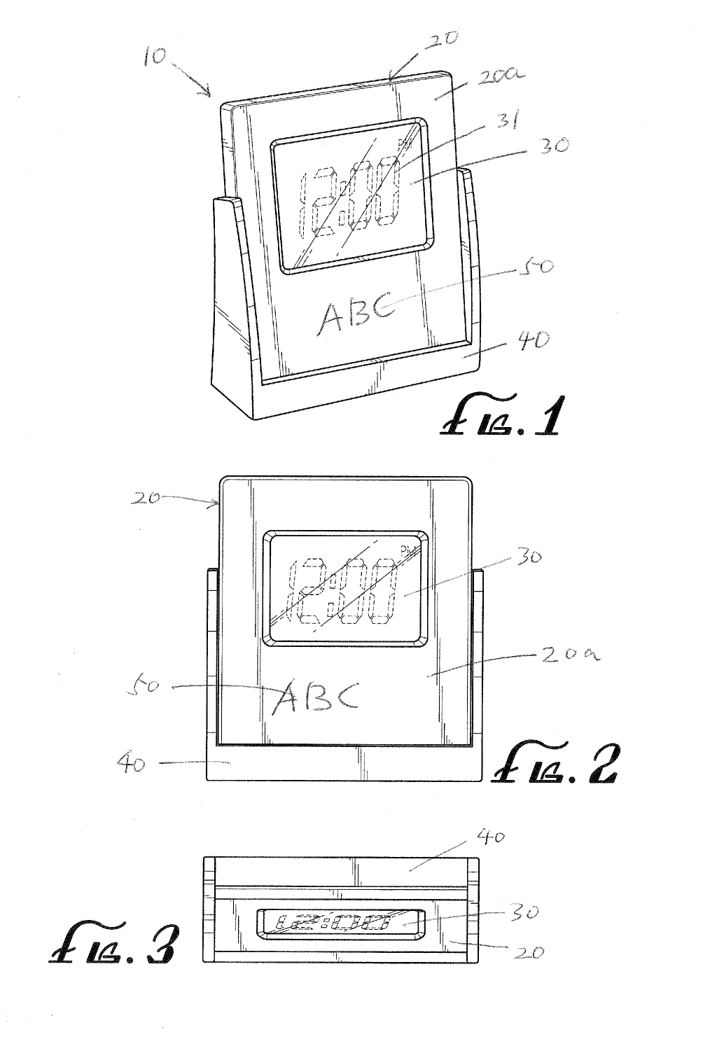

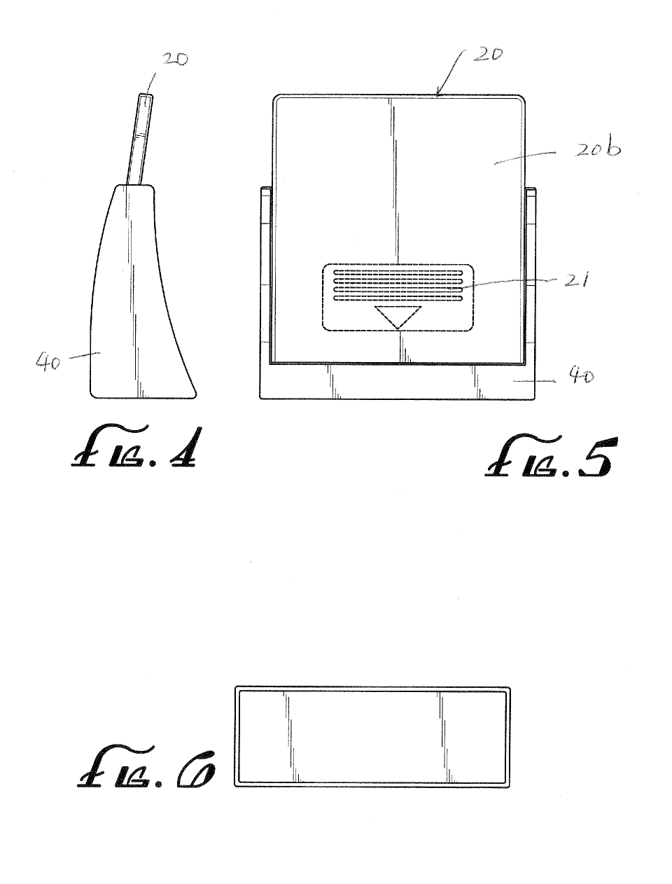

Now referring to FIG. 1-6, the multi-signal desktop digital displayer 10 made in the preferred embodiment of the present invention comprises largely a housing 20, a plurality of digital signal generators encased with the housing 20, a display screen 30 for displaying different unique kinds of digital information 31 generated by the signal generators, and a motion sensor disposed on the housing 20. The housing 20 has a substantially flat front surface 20a and an opposing rear surface 20b to define an enclosure therebetween to retain the electric circuitry for the digital signal generators and the motion sensor therein. The housing 20 is retained, either removably or fixedly, in a stand 40 in a substantially upright position in the preferred embodiment. In another embodiment, however, the housing 20 may have a flat bottom 21 substantially perpendicular to the front surface 20a and integrally formed with the housing 20 so that the displayer 10 may stand thereon.

The digital signal generators (not shown) in the preferred embodiment are a digital clock, a countdown alarm, a timer, and a thermometer, each generating five different kinds of unique digital signal 31, which are, respectively, time, date, alarm setting, timer setting, and current temperature. The electric circuitry for each digital signal generator is well known in the art and thus, not described herein further. For setting time or alarming time, or activating and deactivating timer, a plurality of control buttons may be formed on an outer surface of the housing 20, preferably, on the rear surface 20b. Further, for emitting alarm sound, a tiny speaker, or sound outlet may be formed on the housing 20. Preferably, the power to operate the electric circuitry of the signal generators, the motion sensor, and the display screen 40 is supplied from conventional AA or cell batteries contained in a battery compartment 21 formed, preferably, at the rear surface 20b of the housing 20 as shown in FIG. 5.

The display screen 30 is formed on the front surface 20a of the housing 20 and, in the preferred embodiment, a liquid crystal display (LCD) is used. In another embodiment, however, any other displaying technology well known to those skilled in the art, such as a light emitting diode (LED), may be used.

In the preferred embodiment, the display screen 30 displays only a single kind of digital signal 31. For selective displaying of different kinds of digital signals 31, a motion sensor (not shown) is disposed on the housing 20 and electrically connected to the signal generators. The motion sensor emits invisible electromagnetic wave to define ‘motion field’ around the displayer 10 in which any motion interrupting the emitted wave, such as a user's hand waving, is detected by the sensor. Upon each detection of a motion in the motion field, the sensor generates an electric signal which activates one of the signal generators to display the unique digital signal 31 on the display screen 30. The electric circuitry is configured such that upon each receipt of the electric signal from the sensor, it consecutively activates a different kind of signal generator according to a predetermined order. The circuitry for such an operation is well known to those skilled in the art, ant therefore, not described herein further. In the preferred embodiment, the digital signal 31 displayed on the display screen 30 is changed from one to another among five modes, that is, time, date, alarm setting, timer setting, and temperature, each time a user waves her or his hand or otherwise creates other motion within the ‘motion field’ of the sensor.

The sensor is, preferably, the typical kind of pyroelectric infrared detectors making use of infrared light. However, any other kind of motion sensors that are recognized by one skilled in the art may be used. Similarly, the emitted light may of any other wavelength range that is known in the art as being available for a sensing device, and the range of ‘motion field’ may be short or long in distance, and narrow or wide in angular width, depending on different designs. Therefore, in one embodiment for example, the sensor may be configured to detect a motion occurring only in upper close proximity of the displayer 10, or in another, only in front close proximity of the displayer 10.

The housing 20 and the stand 40 may be fabricated of any proper material, including but not limited to, wood, metal, plastics, cardboard, polymeric compositions, fiberglass, hardboard, or any other rigid or semi-rigid material.

The present invention provides an effective means for advertising and promotion. Since the multi-signal desktop displayer would be more likely to attract attentions of the user and other viewers owing to the interesting way of selecting different integrated digital functions, it can be an effective vehicle for advertisement as well. FIGS. 1 and 2 show that advertising materials 50 imprinted on the front surface 20a of the housing 20, preferably below the display screen 30. But, the advertising material may be imprinted on any outer surface of the housing 20 or the stand 40.

The present invention is capable of embodiments other than those described above, and its several details are capable of modifications in various respects apparent to those of ordinary skill in the art, all without departing from the essential spirit or attributes of the invention, Therefore, the embodiments described hereinbefore should be considered to be merely illustrative, not restrictive.

1. A multi-signal displayer comprising:
a housing;
a plurality of digital signal generators disposed within the housing, each of the digital signal generators being configured to output a unique respective digital signal;
a motion sensor disposed on the housing and emitting electromagnetic wave to define a motion field extending therefrom, the motion sensor being configured to sense motion within the motion field and generate an electrical signal for selectively activating the digital signal generators thereby; and
a display disposed on the housing and configured to display a different respective one of the digital signals upon sensing motion within the field.

2. The multi-signal displayer as in claim 1, wherein the wave is substantially invisible.

3. The multi-signal displayer as in claim 2, wherein the wave is infrared light.

4. The multi-signal displayer as in claim 2, wherein the motion field extends from a location on the housing proximate the display.

5. The multi-signal displayer as in claim 1, wherein the digital signals include at least three unique digital signals selected from the group consisting of: time, date, alarm, timer, and temperature.

6. The multi-signal displayer as in claim 5, wherein the digital signals include five unique digital signals.

7. The multi-signal displayer as in claim 6 further comprising a plurality of input units disposed on an outer surface of the housing.

8. The multi-signal displayer as in claim 1, wherein the display is a liquid crystal display.

9. The multi-signal displayer as in claim 1, wherein the display is a light emitting diode.

10. The multi-signal displayer as in claim 1, wherein the housing has a flat bottom which is perpendicular to the front surface thereof.

11. The multi-signal displayer as in claim 1 further comprising a stand connected to the housing for maintaining the housing in a substantially upright position.

12. The multi-signal displayer as in claim 1 further comprising advertising material disposed on a visible outer surface thereof.

13. A method of advertising comprising the steps of:
a) providing a multi-signal displayer comprising:
a housing,
a plurality of digital signal generators disposed within the housing, each of the digital signal generators being configured to output a unique respective digital signal,
a motion sensor disposed on the housing and emitting electromagnetic wave to define a motion field extending therefrom, the motion sensor being configured to sense motion within the motion field and generate an electrical signal for selectively activating the digital signal generators thereby, and
a display disposed on the housing and configured to display a different respective one of the digital signals upon sensing motion within the field; and
b) disposing advertising material on a visible outer surface of the multi-signal displayer.
